(19) United States
(12) Patent Application Publication
(10) Pub. No.: US 2010/0228469 A1
(43) Pub. Date: Sep. 9, 2010

(54) METHOD AND SYSTEM FOR OVERLAYING LANDMARK INFORMATION ON A GEOCODED GRAPHIC

(76) Inventor: Kavita Varadarajan, Cupertino, CA (US)

Correspondence Address: QUINN LAW GROUP, PLLC, 39555 ORCHARD HILL PLACE, SUITE # 520, NOVI, MI, 48375, US

(21) Appl. No.: 12/398,262

(22) Filed: Mar. 5, 2009

(51) Int. Cl. G01C 21/36; G06F 17/30

(52) U.S. Cl. 701/200; 707/E17.018; 707/E17.001

(57) ABSTRACT

A method for generating enhanced map data includes generating a geocoded graphic of an area using a map portal, the graphic including a recommended route, and then transforming landmark data including traffic control device information for the route into representative icons. The icons are overlaid onto the route to form at least part of the enhanced map data, which is displayed on a computer display. A data server in communication with at least one information source and a computer device having a display screen includes a central processing unit (CPU) and an algorithm executable by the CPU. Execution of the algorithm generates the enhanced map data using information from the information source, and automatically displays the enhanced map graphic on the display screen of the computer device. The icons can also be embedded within text-based driving directions that are generated as another part of the enhanced map data.

### TECHNICAL FIELD

The present invention relates generally to the generation of digital maps or other geocoded graphics, and more particularly to a method and a system for spraying or overlaying traffic control device locations and other landmark-based information onto a geocoded graphic.

### BACKGROUND OF THE INVENTION

The evolution of geographic information systems or GIS using precise geocoding functionality has enabled a host of useful applications for assisting drivers and passengers in reaching a desired destination. As will be understood by those of ordinary skill in the art, the process of geocoding ultimately generates a set of geographic coordinates, e.g., latitude and longitude, using geographic location data provided by a user, typically in the form of a destination address and/or a particular street intersection. The destination and surrounding area can then be precisely mapped using the coordinate data.

As a result, where drivers or travelers were once reliant on cumbersome and potentially outdated paper maps or road atlases, modern travelers can simply input an intended destination into available standalone or web-based software, such as Mapquest, Google Maps, Yahoo! Maps, etc., in order to automatically generate a map or image graphic with an annotated recommended route. Likewise, drivers using portable electronic devices having an integral global positioning satellite (GPS) receiver can enter a desired destination and receive similar information, which is displayed on a screen portion of the portable electronic device.

While such GIS-based applications are invaluable to modern travelers, they remain less than optimal for certain purposes. For example, while a conventional geocoded map displays a recommended route, the recommended route and supporting text-based driving directions are typically presented in terms of distance. This in turn requires a driver to divert attention from the roadway in order to reference an odometer or trip meter. Moreover, distance-based directions are generally inconsistent with the physical references and other landmark-based terminology with which people typically give and understand driving directions.

### SUMMARY OF THE INVENTION

Accordingly, a method is provided for spraying, superimposing, or otherwise overlaying icons or symbols onto a geocoded graphic, such as a GIS-based map or image. The icons graphically represent physical landmarks, which in an exemplary embodiment includes traffic signals and stop signs located along a recommended route. However, other icons can also be used, such as those representing conspicuous man-made structures and/or natural or topographical features. The icons help a driver navigate the recommended route based primarily on the physical landmarks the driver encounters while traveling along the recommended route, without requiring diversion of the driver's attention from the roadway.

The method can be used in conjunction with any commercially or publicly available GIS-based system or map portal, e.g., Google Maps, Mapquest, Tele Atlas, Yahoo! Maps, public domain portals, or other suitable mapping service. Once the geocoded graphic has been generated with a recommended route, a suitable application programming interface or API can be used to spray or overlay the icons onto the route of the geocoded graphic, and optionally within the text of any text-based driving directions provided in conjunction therewith.

Within the scope of the invention, the icons represent a physical embodiment of a particular landmark, i.e., a traffic signal, a stop sign, and/or any other conspicuous or easily-discernable man-made or natural landmark by which a driver or other traveler might easily navigate. Such landmark information can be stored or resident within one or more external or internal databases, referred to collectively herein as a database management system (DBMS). Once the landmark information has been transformed into a set of corresponding icons and overlaid onto the recommended route of the graphic, the resulting enhanced map data is automatically displayed or presented to the user on a display screen of a computer device, e.g., a personal computer, personal data assistant (PDA), GPS device, cell phone, etc.

The enhanced map data includes the underlying geocoded graphic, which can be a map and/or satellite or other image having the annotated route, and the overlaid icons physically represent the particular type of landmark and the location thereof along the recommended route. The enhanced map data can also include any supporting text-based driving directions, with the icons being embedded within the text itself in an exemplary embodiment, and with the driving directions being presented at least in part in terms of the number and type of such landmarks along the route. That is, the supporting text can be referenced at least in part by the number of landmarks between the starting point and destination point, as will be set forth herein.

A system is provided for generating the enhanced map data described above. The system includes a host machine or a data server having a central processing unit (CPU), suitable memory, and an algorithm for spraying or overlaying icons representing predetermined landmark information onto a geocoded graphic. The landmark information includes at least the location of traffic lights or signals and any stop signs located along a recommended route of the geocoded graphic, and could optionally include other man-made and/or natural landmarks as noted above. The data server is in remote communication with a computer device accessible by a driver or other user, with the DBMS, and with a map portal configured for generating the underlying geocoded graphic.

Using the algorithm, the data server automatically retrieves and processes the landmark information, wherein the information is transformed into a set of representative symbols or icons representing the landmark information. The data server then overlays the icons onto the geocoded graphic, and automatically displays the enhanced map data on a display screen of the computer device. As noted above, the enhanced map data includes supporting text-based driving directions that also can be annotated or embedded with the icons, such that the supporting text-based driving directions are explained in part using the number of such landmarks located along the recommended route.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a server-based system for spraying or overlaying a predetermined set of information onto a geocoded graphic;

FIG. 2 is a graphical flow chart describing an algorithm for spraying or overlaying a predetermined set of information using the system of FIG. 1;

FIG. 3 is a schematic illustration of an exemplary set of enhanced map data that can be generated using the system of FIG. 1; and

FIG. 4 is a schematic illustration of another exemplary set of enhanced map data that can be generated using the system of FIG. 1.

### DESCRIPTION OF THE PREFERRED EMBODIMENTS

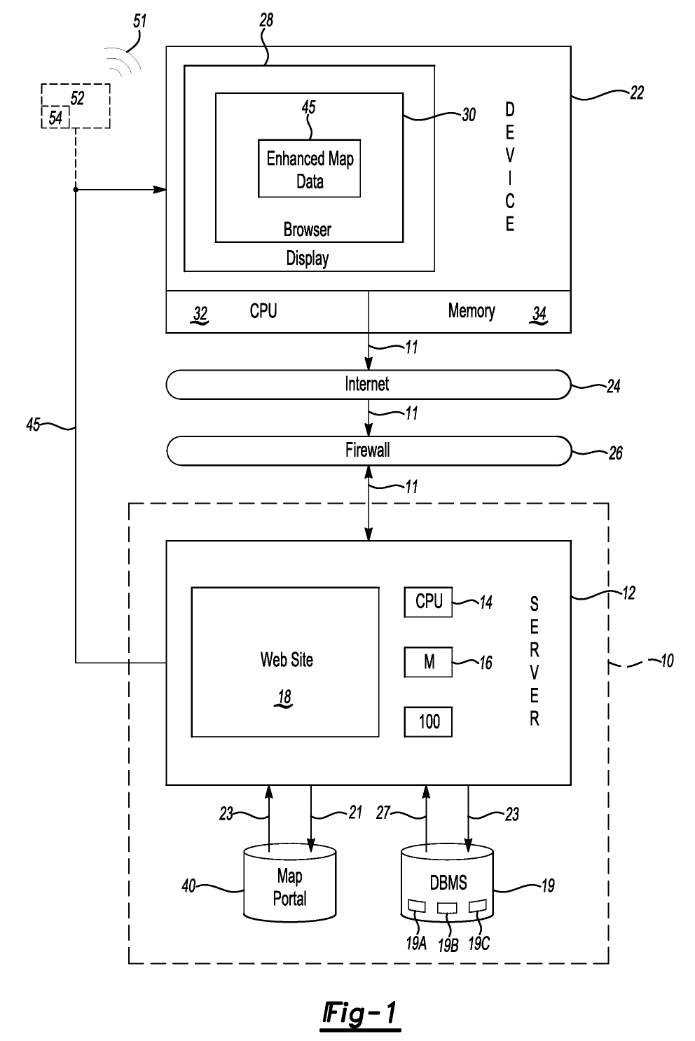

Referring to the drawings, wherein like reference numbers correspond to like or similar components throughout the several figures, and beginning with FIG. 1, a host or server-based system 10 is configured or adapted for generating and displaying a set of enhanced map information or data 45, including an annotated image or map with an annotated recommended driving route, as well as associated text-based driving directions, as described below. The system 10 includes a host machine or data server 12 in communication with each of a web mapping service database or a map portal 40 and a database management system (DBMS) 19. The server 12 includes an algorithm 100 for automatically executing a method of generating the enhanced map data 45 as set forth below, with the server 12 and the algorithm 100 each being remotely accessible by a user having a computer device 22 with a screen portion or a display screen 28 and a web browser 30.

That is, the computer device 22 and the web browser 30 enable a user, such as a driver or passenger of a vehicle either prior to or during a trip, to remotely establish a network connection with the server 12 over the Internet 24 or any other suitable communications network. To enhance system security, such a connection can be made through a firewall 26 and/or using other suitable security measures or devices. The computer device 22 can be a personal computer, personal data assistant (PDA), global positioning system (GPS) receiver, cell phone, or other portable or stationary computing device having such a display screen 28 and web browser 30, and having a central processing unit (CPU) 32 and suitable memory 34 for transmitting, receiving, processing, and displaying the various signals as set forth hereinbelow.

Within the scope of the invention, the server 12 hosts a website 18 running, for example, Internet Information Services (IIS) available through Microsoft Corporation, Apache available through the Apache Software Foundation, etc. The server 12 can use the hyper text transfer (HTTP) or HTTP secure (HTTPS) protocols. Implementation of the website 18 can include static and dynamic HTML pages, form layouts, business logic, etc., and can be accomplished using JavaScript and/or XML-based application pages, as will be understood by those of ordinary skill in the art.

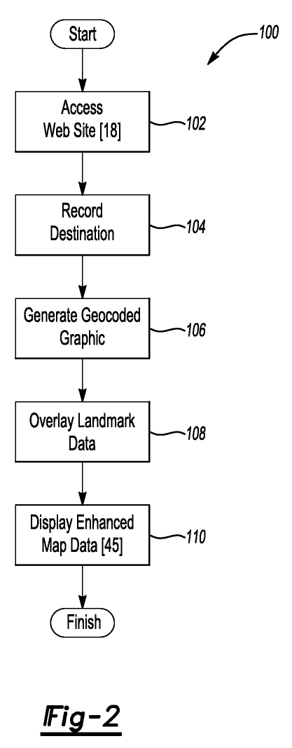

Still referring to FIG. 1, the server 12 can be configured as a digital computer generally comprising a microprocessor or central processing unit (CPU) 14, and computer-readable media or memory (M) 16 such as read only memory (ROM), random access memory (RAM), electrically-programmable read only memory (EPROM), etc. Although not shown in FIG. 1 for clarity, the server 12 can also include a high speed clock, analog to digital (A/D) and digital to analog (D/A) circuitry, and input/output circuitry and devices (I/O), as well as appropriate signal conditioning and buffer circuitry. Any algorithms resident in the server 12, or accessible thereby, including the algorithm 100 described below with reference to FIG. 2, can be stored in memory 16 and automatically executed to provide the required functionality.

The server 12 is in communication with the DBMS 19 and a map portal 40, either via a hardwired or a high-speed wireless connection, to thereby form the system 10. With respect to the map portal 40 in particular, this database or remote server provides a baseline web mapping capability in the form of a Geographic Information System (GIS)-based service integrating the necessary hardware, software, design, implementation, generation, and delivery of a baseline geocoded graphic, e.g., a geocoded map, image, etc., and any associated map-based information. For example, the underlying digital mapping information and related functionality of the map portal 40 can be provided by Navteq, Tele Atlas, Mapquest, Google Maps, Yahoo! Maps, and various public domain sources.

Map portals such as Google Maps and Yahoo! Maps provide a map developer Application Programming Interface (API). As will be understood by those of ordinary skill in the art, using Javascript or another suitable software-based means an API allows third party software, such as the website 18, to receive any digital annotated maps generated by the API, and to freely embed these annotated maps within the web pages provided by the third party software. Thus, in FIG. 1 the server 12 is operable for querying the map portal 40 with a specific destination (arrow 21), and for receiving geocoded graphic 23 in response to such a query. The server 12 can temporarily store the geocoded graphic 23 in memory 16 for use with the algorithm 100 as explained below.

With respect to the DBMS 19, one or more databases, represented in FIG. 1 as the databases 19A, 19B, and 19C, store or contain up-to-date information regarding the type and location of a predetermined set of landmark data or information 27, such as but not limited to: the location and descriptive information regarding traffic lights/signals and/or signs, notable or conspicuous man-made structures such as buildings, bridges, towers, railroad tracks, etc., natural or topographical features such as hills, trees, bodies of water, etc., and/or other conspicuous fixed man-made structures or natural features, i.e., structure or features that a driver or traveler can easily discern while driving, and by which the driver or traveler might easily navigate. The DBMS 19 can be populated with any publically available Department of Transportation information, county information, township information, and/or private database information, in order to optimize the accuracy of the landmark information 27.

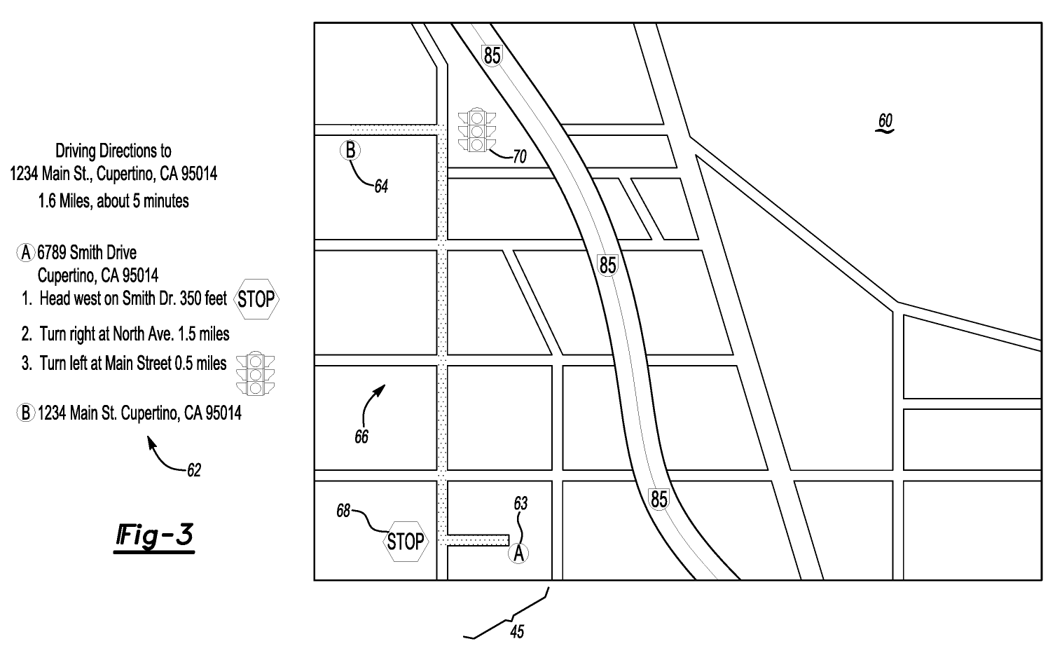

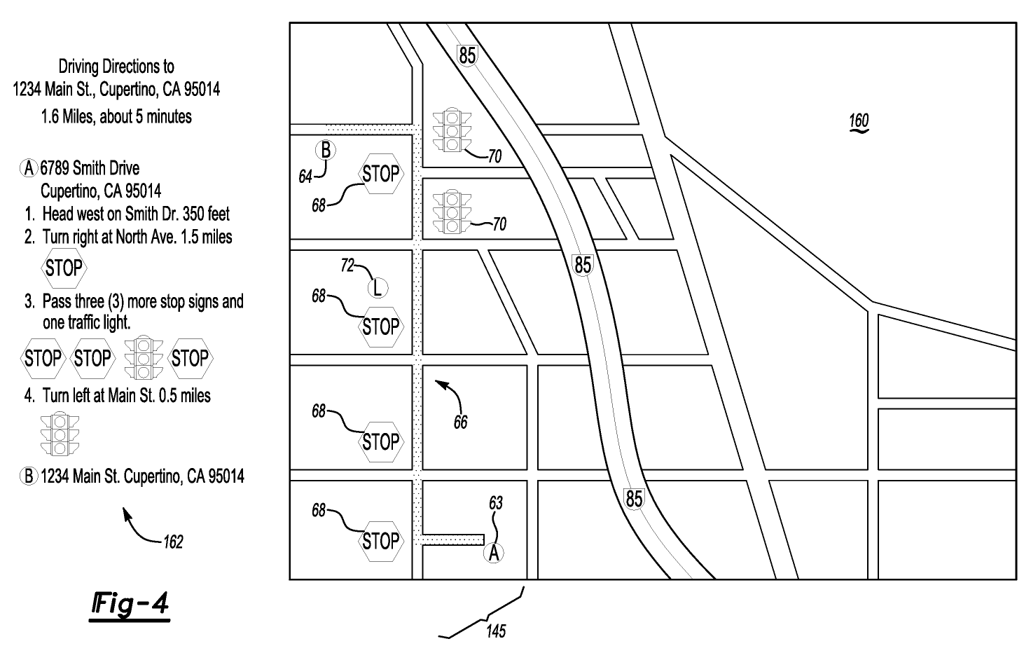

Using the map portal 40 in conjunction with the DBMS 19, the server 12 processes or transforms the landmark information 27 via the CPU 14 into a set of symbols or icons, such as the icons 68, 70, and 72 of FIGS. 3 and 4 as described below. These symbols or icons represent the physical appearance of the particular landmark. The server 12 then sprays, layers, or otherwise overlays the landmark information 27 in the form of icons onto the geocoded graphic 23. Once the required landmark information 27 has been properly overlaid in the form of descriptive symbols or icons 68, 70, and 72 (see FIGS. 3 and 4), supporting text in the form of textual messages or directions 62, 162 (see FIGS. 3 and 4) can be displayed in conjunction with the icons to provide a more intuitive and user-friendly or visual-based set of driving directions.

Referring to FIG. 2 in conjunction with the structure detailed in FIG. 1, the algorithm 100 for spraying or overlaying the icons generated by transforming the landmark information 27 as set forth above begins with step 102, wherein a user of the computer device 22 of FIG. 1 accesses the website 18 of the server 12. That is, if the website 18 is configured as a private or commercial site, necessary user identification and confirmation login techniques can be provided, such as requiring a user name, user ID, token generation, one-time password (OTP) generation, etc. If a public site, the user can access the website 18 by typing or entering a predetermined URL into the web browser 30. Once the user has accessed the website 18, the algorithm 100 proceeds to step 104.

At step 104, the user enters a desired destination, and optionally enters a starting point, which is then recorded by the server 12 in memory 16. The destination can be entered as, for example, an address, city, town, street intersection, etc. Once recorded, the algorithm 100 proceeds to step 106.

At step 106, the server 12 automatically accesses the map portal 40, relays the destination data, and receives as a reply a geocoded graphic 23. The geocoded graphic 23 includes a geocoded map and/or image of the destination and the surrounding area. The server 12 temporarily records the geocoded graphic 23 in memory 16, and the algorithm 100 proceeds to step 108.

At step 108, the server 12 accesses or queries the DBMS 19 using the underlying geocoded location of the area covered in the geocoded graphic 23. The DBMS 19 generates, extracts, or otherwise determines the landmark information 27 in response to the query, which is then processed by the CPU 14 of the server 12. In processing the landmark information 27, the CPU 14 transforms the landmark information into a set of symbols or icons that physically represent the landmarks, i.e., an icon of a traffic light, stop sign, or other manmade or natural landmark as explained above. The server 12 then sprays, layers, or otherwise overlays the icons, such as the icons 68, 70, and 72 shown below in FIGS. 3 and 4, onto the geocoded graphic 23, and the resulting enhanced map data 45 can be temporarily stored or recorded in memory 16. The algorithm 100 then proceeds to step 110.

At step 110, the enhanced map data 45 is automatically displayed to the user on the user's computer device 22 via the display screen 28 and/or web browser 30 thereof. Depending on the particular configuration of the computer device 22, an optional audio speaker 52 can be provided with voice-recognition software 54 suitable for broadcasting the supporting text 62, 162 as directions 51. That is, using the audio speaker 52 and the software 54, a user could listen to the directions while driving without diverting attention from the roadway.

Referring to FIG. 3, an exemplary embodiment of a set of enhanced map data 45 includes an annotated map 60 having an annotated route 66 and text-based driving directions 62 with the overlaid icons 68, 70, and/or 72. In this embodiment, a driver beginning at a starting point 63, labeled as point A in FIG. 3, is alerted via the icon 68, both on the annotated map 60 and within the text of the driving directions 62, that a stop sign is located at the intersection of Smith Dr. and North Ave. In this example, the icon 68 is configured to represent the physical appearance of a stop sign. Likewise, the driver can be alerted via the icon 70, here configured to represent a traffic signal, both on the map 60 and within the directions 62 that there is another landmark in the form of a traffic light, with the icon 70 marking the location of the final turn. The destination 64 is labeled as point A in FIG. 3, with the annotated route 66 defined by the route between points A and B.

As all traffic lights and stop signs along the annotated route 66 are intended to be properly marked with a corresponding icon, a driver using the map 60 is not required to divert attention from the roadway and to an odometer or trip meter in order to determine precisely when to turn. That is, in the embodiment of FIG. 3, a mere glance at the map 60 informs the driver to “turn right at the stop sign, then turn left at the next traffic light”. Distances between these locations remain available to the driver within the text of the driving directions 62, but reliance on the distances is not required for effective navigation due to the precise number and placement of the various icons 68 and 70 on the map 60.

Referring to FIG. 4, another exemplary embodiment of a set of enhanced map data 145 includes an annotated map 160 having the annotated route 66 and another set of text-based directions 162. In this embodiment, a driver beginning at a starting point 63, also labeled as point A in FIG. 4, is alerted to the presence of stop signs via a plurality of stop sign icon 68, both on the annotated map 160 and within the text of the directions 162. For example, there is a first stop sign at the intersection of Smith Dr. and North Ave. Once the driver turns onto North Ave., the driver passes through three more stop signs prior to reaching a first traffic light. The driver then passes another stop sign before reaching another traffic signal marking the intersection with Main Street. As with FIG. 3, stop sign icons 68 and traffic signal icons 70 are overlaid on the map 160 and the directions 162 to alert the driver to the presence of landmarks in the form of stop signs and traffic lights, respectively.

While the icons 68 and 70 graphically represent specific traffic control devices as the aforementioned landmarks, other symbols or icons, such as a landmark icon (L) 72, can be placed on the map 160 and/or within the directions 162 as needed to provide further landmark-based navigational information. For example, the landmark icon 72 in FIG. 4 might be configured as a symbol or a picture representing a cell tower, bridge, building, hill, lake, or other suitably conspicuous landmark as described above. A driver could then, with but a glance at the map 160, determine to “turn right at the first stop sign, continue past three stop signs, past a traffic light, and then past a final stop sign, with a cell tower appearing on the left just before the final stop sign. Turn left at the next traffic light after the final stop sign”. As with FIG. 3, the destination 64 is labeled as point A in FIG. 4, with the annotated route 66 defined by the route between points A and B.

In either of the embodiments of FIGS. 3 and 4, and depending on the configuration and capabilities of the computer device 22 of FIG. 1, the driving directions 62, 162 can be automatically processed and broadcast by the speech-recognition software 54. Such a feature can have particular utility when using a hand-held GPS device or a vehicle-mounted navigation system, as such devices can further optimize the hands-free use of the system and method of the invention as set forth hereinabove.

While the best modes for carrying out the invention have been described in detail, those familiar with the art to which this invention relates will recognize various alternative designs and embodiments for practicing the invention within the scope of the appended claims.

1. A method for generating enhanced map data, the method comprising:
generating a geocoded graphic of an area using a map portal, the geocoded graphic including at least a recommended route for reaching a destination point within the area;
transforming a set of landmark-based information for the recommended route into a corresponding set of icons, wherein the landmark-based information describes the type and location of a plurality of traffic control devices along the recommended route;
overlaying the icons onto the geocoded graphic to thereby generate a graphic portion of the enhanced map data; and
displaying at least the graphic portion of the enhanced map graphic on a computer display.

2. The method of claim 1, further comprising:
recording a starting point and the destination point in a memory location of a data server;
generating a set of text-based driving directions suitable for reaching the destination point from the starting point;
embedding the icons into the text-based driving directions as a text portion of the enhanced map graphic; and
displaying the text portion of the enhanced map graphic on a computer display.

3. The method of claim 2, further comprising:
processing the text-based driving directions using voice-recognition software to thereby generate an audible speech signal; and
broadcasting the audible speech signal.

4. The method of claim 1, wherein the icons include at least one of a stop sign icon and a traffic light icon.

5. The method of claim 1, further comprising:
establishing a network connection between a data server and a database management system (DBMS) that is located remotely from the data server; and
automatically extracting the set of landmark-based information from the DBMS.

6. A method for generating enhanced map data, the method comprising:
recording a starting point and a destination point in a memory location of a data server;
generating a geocoded map of the destination point and an area surrounding the destination point, the geocoded map including at least a recommended route suitable for reaching the destination point from the starting point;
processing a set of landmark information for the area, wherein the set of landmark information describes the locations of a plurality of traffic control devices that are located along the recommended route;
transforming the landmark information into a corresponding set of icons each graphically representing one of the traffic control devices;
overlaying the icons onto the recommended route of the geocoded graphic to thereby generate a graphic portion of the enhanced map data; and
displaying at least the graphic portion of the enhanced map data on a computer display that is located remotely from the data server.

7. The method of claim 6, wherein generating a geocoded map includes:
remotely accessing a map portal;
transmitting the starting point and the destination point to the map portal;
using the map portal to generate the geocoded map;
receiving the geocoded map from the map portal; and
temporarily recording the geocoded map in the memory location of the data server.

8. The method of claim 6, wherein processing a set of landmark information for the area includes:
extracting the set of landmark information from a database located remotely from the data server; and
temporarily recording the set of landmark information in the memory location of the data server.

9. The method of claim 6, wherein transforming the set of landmark information into a corresponding set of icons includes generating at least one of a traffic signal icon and a stop sign icon.

10. The method of claim 9, wherein transforming the set of landmark information into a corresponding set of icons further includes generating at least one additional icon representing one of a topographical feature and a manmade structure.

11. The method of claim 6, further comprising:
generating a set of text-based driving directions suitable for reaching the destination point from the starting point;
embedding the set of icons into the text-based driving directions as a text portion of the enhanced map data; and
displaying the text portion of the enhanced map data on the computer display.

12. A data server in communication with at least one external information source and a computer device having a display screen, the data server comprising:
a central processing unit (CPU); and
an algorithm executable by the CPU and adapted for generating enhanced map data using information from the at least one information source, and for automatically displaying the enhanced map data on the display screen of the computer device;
wherein the enhanced map data includes at least a geocoded map having a recommended route between a starting point and a destination point, and a plurality of landmark-based icons that are overlaid on the geocoded map along the recommended route, the plurality of landmark-based icons including at least one of a traffic signal icon and a stop sign icon.

13. The data server of claim 12, wherein the at least one information source includes a database containing a set of traffic control device information as a first portion of the information and a map portal operable for generating a geocoded map of an area including the recommended route as a second portion of the information.

14. The data server of claim 12, wherein the data server is further operable for determining text-based driving directions corresponding to the recommended route, and for embedding the plurality of icons within the text-based driving directions as a text portion of the enhanced map data.

15. The data server of claim 14, wherein the data server is further operable for displaying the text-based driving directions in terms of the number of the icons appearing along the recommended route.
